(19) United States
(12) Patent Application Publication
(10) Pub. No.: US 2022/0276620 A1
(43) Pub. Date: Sep. 1, 2022

(54) IMPROVED MODEL-FREE ADAPTIVE CONTROL METHOD

(71) Applicants: DALIAN UNIVERSITY OF TECHNOLOGY, Dalian, Liaoning (CN); DUT ARTIFICIAL INTELLIGENCE INSTITUTE, DALIAN, Dalian, Liaoning (CN)

(72) Inventors: Ximing SUN, Dalian, Liaoning (CN); Sixin WEN, Dalian, Liaoning (CN); Xian DU, Dalian, Liaoning (CN); Yanhua MA, Dalian, Liaoning (CN); Xiaoyu LIU, Dalian, Liaoning (CN); Yuwen HAO, Dalian, Liaoning (CN)

(21) Appl. No.: 17/440,052

(22) PCT Filed: Sep. 9, 2020
(86) PCT No.: PCT/CN2020/114129

§ 371 Date: Sep. 16, 2021

(30) Foreign Application Priority Data
Aug. 25, 2020 (CN) 202010863628.X

(51) Int. Cl. G05B 13/04; G06F 17/16; G06F 17/15

(52) U.S. Cl. CPC G05B 13/042; G06F 17/16; G06F 17/15

(57) ABSTRACT

The present invention discloses an improved model-free adaptive control method, in particular to an improved method for a compact dynamic linearization model-free adaptive control based on MIMO systems, and belongs to the field of control algorithm design. Firstly, proportional control is added in CFDL-MFAC to improve the problems of low response speed and large overshoot in the original control system. Secondly, an anti-windup control algorithm of an actuator is added in the above control structure so that the actuator does not conduct transfinite operation when reaching the upper or lower saturation limit and the actuator can quickly make a control response when a control instruction enters an unsaturated region again to improve the control accuracy of the system. Then, it is proved through strict analysis that the improved control algorithm can ensure tracking error and BIBO stability under certain conditions. Finally, the above control algorithm is applied to an aero-engine control system, and the effectiveness and superiority of the above control algorithm can be obtained by numerical experiments.

### TECHNICAL FIELD

The present invention discloses an improved method for a compact dynamic linearization model-free adaptive control based on Multiple-Input Multiple-Output (MIMO) systems, and belongs to the field of control algorithm design.

### BACKGROUND

With the technological innovation and industrial progress, people have higher requirements for the safety, stability and efficient control of the aircraft, and the model-based control concept is greatly affected by the modeling accuracy. In addition, the model obtained by mathematical modeling will gradually deviate from the actual control object due to unmodeled dynamics problems and engine mechanical wear. These control blind spots cause the control effects to be worse with the extension of use time. Therefore, a model-free adaptive control (MFAC) algorithm emerges at the right moment.

MFAC is a data-driven control method. And the parameter design does not depend on the structure of a control object, that is, it does not need to model the controlled object or identify the parameters, but only designs the control parameters through the input and output data of the control system. The method was first proposed by Hou Zhongsheng, including the new dynamic linearization method and the concept of a pseudo Jacobian matrix (PJM). The pseudo Jacobian matrix can be directly estimated from the input and output data. In the past two decades, the method has obtained important research results in theory and application. Studies have shown that the MFAC method is easier to be used and has better control effect than other DDC methods, such as IFT and VRFT.

Recently, many literatures have mentioned the extended research and application of the MFAC algorithm, such as adaptive iterative learning control, adaptive online learning control and model-free adaptive decoupling control. In addition, in the past five years, the research upsurge of combining the MFAC algorithm with iterative learning has gradually increased. For example, the adaptive iterative learning control method is used to solve the problem of macro highway traffic density control of ramp control, the problem of random packet loss and the problems of parking control and tracking control of train tracks in railway stations. In addition, the combination of the neural network with MFAC has also been applied. However, most of the previous aero-engine control studies focus on model-based control. Therefore, it is of important practical significance to extend MFAC to the field of aero-engine control. The MFAC control strategy uses the input and output data of the system to update the PJM in real time through a parameter estimation algorithm, so that the controller parameters can be updated in real time to allow the controller to carry out timely and stable control on the aircraft in case of serious change in the flight environment, so as to ensure safe flight of the aircraft at different flight heights and atmospheric environment.

### SUMMARY

In view of the deficiencies of the existing compact dynamic linearization model-free adaptive control method in discrete simulation application of complex models, the present invention proposes an improved method for a compact dynamic linearization model-free adaptive control based on MIMO systems, which is suitable for the design and application fields of control systems and can be used for improving the performance of the control systems and mainly solving the problems of low response speed, large overshoot and actuator saturation in the model-free adaptive control method.

The technical solution of the present invention is as follows:

An improved method for a compact dynamic linearization model-free adaptive control (CFDL-MFAC) based on MIMO systems comprises the following steps:

step A: analyzing the existing method for the compact dynamic linearization model-free adaptive control, and from experimental results, finding that the application process has deficiencies in response time and stability;

the MIMO discrete-time nonlinear system is expressed as follows.

y(k+1)=f(y(k), . . . ,y(k−n_{y}),u(k), . . . ,u(k−nᵤ)) (1)

wherein u(k) and y(k) are system inputs and system outputs at time k, respectively; n_{y} and nᵤ are two unknown integers; f( . . . )=(f₁( . . . ), . . . , fₘ( . . . )) is an unknown nonlinear function;

when f has a continuous partial derivative condition and formula (1) satisfies a generalized Lipschitz condition, expressing formula (1) as the following CFDL data model form:

$$Δ y ( k + 1 ) = {Φ}_{c} ( k ) Δ u ( k ) wherein {Φ}_{c} ( k ) = [ \begin{matrix}{ϕ}_{11} ( k ) & {ϕ}_{12} ( k ) & … & {ϕ}_{1 m} ( k ) \\ {ϕ}_{21} ( k ) & {ϕ}_{22} ( k ) & … & {ϕ}_{2 m} ( k ) \\ ⋮ & ⋮ & ⋮ & ⋮ \\ {ϕ}_{m 1} ( k ) & {ϕ}_{m 2} ( k ) & … & {ϕ}_{mm} ( k )\end{matrix} ] ∈ {R}^{m \times m} ; \qquad ( 2 )$$

firstly, proposing the following assumptions:

assumption 1: Φ_{c}(k) as a pseudo Jacobian matrix of the system shall be a diagonal dominant matrix which satisfies the following conditions: |ϕᵢⱼ|≤b₁,b₂≤|ᵢᵢ(k)|≤αb₂,α≥1,b₂>b₁(2α+1)(m−1), i=1, . . . ,m, j=1, . . . ,m, i≠j; b₁ and b₂ are set as bounded constants, i and j are set as row and column indexes of the matrix; and the signs of all elements in Φ_{c}(k) remain the same at any time k;

expressing a control input criterion function as formula (3):

J(u(k))=∥y*(k+1)−y(k+1)∥²+λ∥u(k)−u(k−1)∥² (3)

wherein λ>0 represents a weight factor, which is used to punish the change of excessive control input quantity; y*(k+1) is a desired output signal;

substituting formula (2) into formula (3), deriving u(k) and making the equation equal to zero to obtain a control input algorithm as follows:

$$u ( k ) = u ( k - 1 ) + \frac{{ρΦ}_{c}^{T} ( k ) ( {y}^{*} ( k + 1 ) - y ( k ) )}{λ + {‖ {Φ}_{c} ( k ) ‖}^{2}} \qquad ( 4 )$$

considering the following parameter estimation criteria function:

J(Φ_{c}(k))=∥Δy(k)−Φ_{c}(k)Δu(k−1)∥²+μ∥Φ_{c}(k)−\hat{Φ}_{c}(k−1)∥² (5)

wherein μ is a weight factor used to punish excessive changes in PJM estimates; \hat{Φ}_{c}(k) is an estimate of Φ_{c}(k);

deriving Φ_{c}(k) in formula (5) and making the equation equal to zero to obtain a parameter estimation algorithm as follows:

$${\hat{Φ}}_{c} ( k ) = {\hat{Φ}}_{c} ( k - 1 ) + \frac{η ( Δ y ( k ) - {\hat{Φ}}_{c} ( k - 1 ) Δ u ( k - 1 ) ) Δ {u}^{T} ( k - 1 )}{μ + {‖ Δ u ( k - 1 ) ‖}^{2}} \qquad ( 6 )$$

conducting parameter estimation in each k by the above control parameter estimation algorithm to provide control inputs at the time; however, the calculation of the parameter estimation algorithm needs to occupy a certain time, causing slow system response and causing the control algorithm to be limited in use for a system with a small requirement for a control period; and the system vibrates greatly under non-ideal conditions from the experimental results;

step B: based on the above problems of slow response and vibration, considering the following improved solution;

Δu(k)=Δuₘ(k)′+Δuₚ(k) (7)

wherein uₘ(k)′ is MFAC controller output, and Δuₚ(k) is proportional controller output expressed by the following formulas:

$$\begin{matrix}Δ {u}_{m} ( k ) = \frac{{ρΦ}_{c}^{T} ( k ) ( {y}^{*} ( k + 1 ) - y ( k ) )}{λ + {‖ {Φ}_{c} ( k ) ‖}^{2}} & ( 8 ) \\ Δ {u}_{p} ( k ) = β K ( {y}^{*} ( k + 1 ) - y ( k ) ) - β K ( {y}^{*} ( k ) - y ( k - 1 ) ) & ( 9 )\end{matrix}$$

proposing the following anti-windup algorithm as part of the proposed control algorithm: stopping updating an integrator when an actuator is at an upper saturation limit and there is still a growing trend, or when the actuator is at a lower saturation limit and is still decreasing; otherwise, the integrator works normally; that is, in the case of saturation, only the integral operations that help to reduce the degree of saturation are performed, and expressed by the following formulas:

$$\begin{matrix}Δ {{u}_{m} ( k )}^{′} = Δ {u}_{m} ( k ) f ( k ) & ( 10 ) \\ f ( k ) = \{ \begin{matrix}0 , & u ( k ) > {u}_{-} max ⩓ Δ u ( k ) > 0 , u ( k ) < {u}_{-} min ⩓ Δ u ( k ) < 0 \\ 1 , & otherwise\end{matrix} & ( 11 )\end{matrix}$$

wherein u_max and u_min are the upper and lower limitations of the actuator;

proposing the following control solution based on formulas (6), (7), (8) and (9):

$$\begin{matrix}{\hat{ϕ}}_{ii} ( k ) = {\hat{ϕ}}_{ii} ( 1 ) , if \vert {\hat{ϕ}}_{ii} ( k ) \vert < {b}_{2} or \vert {\hat{ϕ}}_{ii} ( k ) \vert > α {b}_{2} or sign ( {\hat{ϕ}}_{ii} ( k ) ) \neq sign ( {\hat{ϕ}}_{ii} ( 1 ) ) i = 1 , … , m & ( 12 ) \\ {\hat{ϕ}}_{ij} ( k ) = {\hat{ϕ}}_{ij} ( 1 ) , if \vert {\hat{ϕ}}_{ij} ( k ) \vert > {b}_{1} or sign ( {\hat{ϕ}}_{ij} ( k ) ) \neq sign ( {\hat{ϕ}}_{ij} ( 1 ) ) , i \neq j & ( 13 ) \\ u ( k ) = u ( k - 1 ) + \frac{{ρΦ}_{c}^{T} ( k ) ( {y}^{*} ( k + 1 ) - y ( k ) )}{λ + {‖ {Φ}_{c} ( k ) ‖}^{2}} f ( k ) + β K ( {y}^{*} ( k + 1 ) - y ( k ) ) - β K ( {y}^{*} ( k ) - y ( k - 1 ) ) & ( 14 )\end{matrix}$$

wherein \hat{ϕ}ᵢⱼ(1) is an initial value of \hat{ϕ}ᵢⱼ(k), i=1, . . . , m; j=1, . . . , m;

step C: for the above improved control algorithm, analyzing the convergence of tracking error and the stability of bounded input and bounded output through theoretical derivation;

firstly, defining the following output errors of the system:

e(k)=y*(k)−y(k) (15)

substituting formula (2) and formula (14) into formula (15), and when f(k)=1, obtaining:

$$\begin{matrix}e ( k + 1 ) = e ( k ) - {Φ}_{c} ( k ) Δ u ( k ) = [ I - ( \frac{{ρΦ}_{c} ( k ) {\hat{Φ}}_{c}^{T} ( k )}{λ + {‖ {\hat{Φ}}_{c} ( k ) ‖}^{2}} + {βΦ}_{c} ( k ) K ) ] e ( k ) + {βΦ}_{c} ( k ) K e ( k - 1 ) & ( 16 ) \\ {D}_{j} = \{ z ‖ z - \vert 1 - ( \frac{ρ {\sum }_{i = 1}^{m} {ϕ}_{ji} ( k ) {\hat{ϕ}}_{ji} ( k )}{λ + {‖ \hat{Φ} ( k ) ‖}^{2}} + {βϕ}_{jj} ( k ) {K}_{jj} ) ‖ \leq {\sum }_{l = 1 , l \neq j}^{m} \vert \frac{ρ {\sum }_{i = 1}^{m} {ϕ}_{ji} ( k ) {\hat{ϕ}}_{li} ( k )}{λ + {‖ \hat{Φ} ( k ) ‖}^{2}} + {\sum }_{i = 1}^{m} {βϕ}_{ji} ( k ) {K}_{il} \vert \} & ( 17 )\end{matrix}$$

wherein z is a characteristic value of matrix I−(ρΦ_{c}(k)\hat{Φ}_{c}^{T}(k)/(λ+∥\hat{Φ}_{c}(k)∥²)+βΦ_{c}(k)K) and Dⱼ, j=1, 2, . . . , m is a Gershgorin disk;

formula (17) is equivalent to formula (18);

$${D}_{j} \{ z ‖ z \vert \leq 1 - ( \frac{ρ {\sum }_{i = 1}^{m} {ϕ}_{ji} ( k ) {\hat{ϕ}}_{ji} ( k )}{λ + {‖ \hat{Φ} ( k ) ‖}^{2}} + {βϕ}_{jj} ( k ) {K}_{jj} ) \vert + {\sum }_{l = 1 , l \neq j}^{m} \vert \frac{ρ {\sum }_{i = 1}^{m} {ϕ}_{ji} ( k ) {\hat{ϕ}}_{li} ( k )}{λ + {‖ \dot{Φ} ( k ) ‖}^{2}} + {\sum }_{i = 1}^{m} {βϕ}_{ji} ( k ) {K}_{ii} \vert \} \qquad ( 18 )$$

by resetting algorithms (12) and (13), obtaining |\hat{ϕ}ᵢⱼ|≤b₁ and b₂≤|\hat{ϕ}ᵢᵢ(k)|≤αb₂, i=1, . . . ,m; j=1, . . . ,m; i≠j; from assumption 1, obtaining |ϕᵢⱼ|≤b₁,b₂≤|ϕᵢᵢ(k)|≤αb₂, i=1, . . . ,m; j=1, . . . ,m; i≠j;

from the above conditions, obtaining the following inequalities

$$1 - ( \frac{ρ {\sum }_{i = 1}^{m} \vert {ϕ}_{ji} ( k ) \vert \vert {\hat{ϕ}}_{ji} ( k ) \vert}{λ + {‖ \hat{Φ} ( k ) ‖}^{2}} + {βϕ}_{jj} ( k ) {K}_{jj} ) \leq 1 - ( \frac{ρ \vert {ϕ}_{jj} ( k ) \vert \vert {\hat{ϕ}}_{jj} ( k ) \vert}{λ + {‖ \dot{Φ} ( k ) ‖}^{2}} + {βϕ}_{jj} ( k ) {K}_{jj} ) \leq 1 - ( \frac{ρ {b}_{2}^{2}}{λ + {‖ \dot{Φ} ( k ) ‖}^{2}} + β {K}_{min} {b}_{2} ) \qquad ( 19 )$$

by resetting algorithm formula (11) and assumption 1, obtaining \hat{ϕ}ⱼᵢ(k)ϕⱼᵢ(k)>0, i=1, . . . ,m; j=1, . . . ,m; therefore, there is a λₘᵢₙ, so that when λ>λₘᵢₙ, the following equality holds:

$$\frac{ρ {\sum }_{i = 1}^{m} {ϕ}_{ji} ( k ) {\hat{ϕ}}_{ji} ( k )}{λ + {‖ \hat{Φ} ( k ) ‖}^{2}} + β {ϕ}_{jj} ( k ) {K}_{jj} = \frac{ρ {\sum }_{i = 1}^{m} \vert {ϕ}_{ji} ( k ) \vert \vert {\hat{ϕ}}_{ji} ( k ) \vert}{λ + {‖ \hat{Φ} ( k ) ‖}^{2}} + β {ϕ}_{jj} ( k ) {K}_{jj} \leq ρ \frac{{α}^{2} {b}_{2}^{2} + {b}_{1}^{2} ( m - 1 )}{λ + {‖ \hat{Φ} ( k ) ‖}^{2}} + β α {b}_{2} {K}_{max} < ρ \frac{{α}^{2} {b}_{2}^{2} + {b}_{1}^{2} ( m - 1 )}{{λ}_{min} + {‖ \hat{Φ} ( k ) ‖}^{2}} + β α {b}_{2} {K}_{max} < 1$$

thus, selecting 0<ρ≤1 and λ>λₘᵢₙ such that

$$\vert 1 - ( \frac{ρ {\sum }_{i = 1}^{m} {ϕ}_{ji} ( k ) {\hat{ϕ}}_{ji} ( k )}{λ + {‖ \hat{Φ} ( k ) ‖}^{2}} + β {\hat{ϕ}}_{jj} ( k ) {K}_{jj} ) \vert = 1 - ( \frac{ρ {\sum }_{i = 1}^{m} {ϕ}_{ji} ( k ) {\hat{ϕ}}_{ji} ( k )}{λ + {‖ \hat{Φ} ( k ) ‖}^{2}} + β {\hat{ϕ}}_{jj} ( k ) {K}_{jj} ) \qquad ( 23 )$$

for any λ>λₘᵢₙ, the following inequalities hold obviously

$$0 < {M}_{1} \leq ρ \frac{2 α {{b}_{1}^{2} ( m - 1 )}^{2}}{λ + {‖ \hat{Φ} ( k ) ‖}^{2}} 2 β {K}_{min} α {b}_{1} ( m - 1 ) < \frac{{b}_{2}^{2}}{λ + {‖ \hat{Φ} ( k ) ‖}^{2}} + 2 β {K}_{min} α {b}_{1} ( m - 1 ) \leq \frac{{α}^{2} {b}_{2}^{2} + {b}_{1}^{2} ( m - 1 )}{λ + {‖ \hat{Φ} ( k ) ‖}^{2}} + 2 β {K}_{min} α {b}_{1} ( m - 1 ) < \frac{{α}^{2} {b}_{2}^{2} + {b}_{1}^{2} ( m - 1 )}{{λ}_{min} + {‖ \hat{Φ} ( k ) ‖}^{2}} + 2 β {K}_{min} α {b}_{1} ( m - 1 ) < 1 \qquad ( 24 )$$

from formulas (21), (23) and (24), knowing

$$\vert 1 - ( \frac{ρ {\sum }_{i = 1}^{m} {ϕ}_{ji} ( k ) {\hat{ϕ}}_{ji} ( k )}{λ + {‖ \hat{Φ} ( k ) ‖}^{2}} + β {\hat{ϕ}}_{jj} ( k ) {K}_{jj} ) \vert + {\sum }_{l = 1 , l \neq j}^{m} \vert \frac{ρ {\sum }_{i = 1}^{m} {ϕ}_{ji} ( k ) {\hat{ϕ}}_{ji} ( k ) x}{λ + {‖ \hat{Φ} ( k ) ‖}^{2}} + β {\hat{ϕ}}_{ji} ( k ) {K}_{il} \vert < 1 - {M}_{1} < 1 \qquad ( 25 )$$

from formulas (18) and (24), obtaining

$$s [ I - ( \frac{ρ {Φ}_{c} ( k ) {Φ}_{c}^{T} ( k )}{λ + {‖ {\hat{Φ}}_{c} ( k ) ‖}^{2}} + {βΦ}_{c} ( k ) K ) ] \leq 1 - {M}_{1} \qquad ( 26 )$$

wherein s(M) is the spectral radius of matrix M;
letting

$$A = {‖ I - ( \frac{ρ {Φ}_{c} ( k ) {Φ}_{c}^{T} ( k )}{λ + {‖ {\hat{Φ}}_{c} ( k ) ‖}^{2}} + β {Φ}_{c} ( k ) K ) ‖}_{p}$$

and B=∥βΦ_{c}(k)K)∥ᵥ; from the conclusion of the spectral radius of the matrix, an any small positive number ε₁ exists, such that

$$A \leq s [ I - ( \frac{ρ {Φ}_{c} ( k ) {Φ}_{c}^{T} ( k )}{λ + {‖ {\hat{Φ}}_{c} ( k ) ‖}^{2}} + {βΦ}_{c} ( k ) K ) ] + {ε}_{1} \leq 1 - {M}_{1} + {ε}_{1} < 1 \qquad ( 27 )$$

wherein ∥M∥ᵥ is the compatible norm of matrix M;

β exists such that B satisfies the following inequality:

1>1−A≤M₁−ε₁>B>0 (28)

from formulas (16) and (28), obtaining:

∥e(k+1)∥ᵥ≤A∥e(k)∥ᵥ+B∥e(k−1)∥ᵥ<(1−B)∥e(k)∥ᵥ+B∥e(k−1)∥ᵥ (29)

after transposition, obtaining:

∥e(k+1)∥ᵥ−∥e(k)∥ᵥ<−B(∥e(k)∥ᵥ−∥e(k−1)∥ᵥ) (30)

based on formula (30), discussing the form of e(k) from the following four aspects:

1. when ∥e(k+1)∥ᵥ>∥e(k)∥ᵥ and ∥e(k)∥ᵥ>∥e(k−1)∥ᵥ, obtaining

∥e(k+1)∥ᵥ−∥e(k)∥ᵥ>−B(∥e(k)∥ᵥ−∥e(k−1)∥ᵥ) (31)

which is the opposite of formula (30); therefore, this assumption does not exist;
2. when ∥e(k+1)∥ᵥ>∥e(k)∥ᵥ and ∥e(k)∥ᵥ<∥e(k−1)∥ᵥ from formula (30), obtaining:

$$\frac{{‖ e ( k + 1 ) ‖}_{v} - {‖ e ( k ) ‖}_{v}}{{‖ e ( k - 1 ) ‖}_{v} - {‖ e ( k ) ‖}_{v}} < B < 1 \qquad ( 32 )$$

i.e., the decrease of e(k) is larger than the increase in three adjacent sampling points; and as a result, the overall trend is decreasing under this situation;
3. when ∥e(k+1)∥ᵥ<∥e(k)∥ᵥ and ∥e(k)∥ᵥ<∥e(k−1)∥ᵥ, obtaining

$$\frac{{‖ e ( k + 1 ) ‖}_{v}}{{‖ e ( k ) ‖}_{v}} < 1 and \frac{{‖ e ( k ) ‖}_{v}}{{‖ e ( k - 1 ) ‖}_{v}} < 1 \qquad ( 33 )$$

which satisfies formula (30), and e(k) has a decreasing trend in this case;
4. when ∥e(k+1)∥ᵥ<∥e(k)∥ᵥ and ∥e(k)∥ᵥ>∥e(k−1)∥ᵥ, according to formula (30), this situation may exist; two possibilities exist in the time of k+2 in detail: if ∥e(k+2)∥ᵥ>∥e(k+1)∥ᵥ exists, obtaining the same conclusion as the second case; if ∥e(k+2)∥ᵥ<∥e(k+1)∥ᵥ, obtaining the same conclusion as the third case; in short, e(k) still has a decreasing trend in this case;

the above methods of proof are also applicable when f(k)=0; to sum up, the overall trend of error e(k) is decreasing; therefore, the convergence of the error is proved;

step D: applying the above control algorithm to control of an aero-engine model, and selecting three different cases for result comparison to verify the effectiveness and superiority of the control algorithm; firstly, comparing the control effects of MFAC+Kp, CFDL-MFAC and PID under the standard conditions to illustrate the effectiveness of an improved controller; and then, comparing the control effects at different heights and different delays to illustrate the superiority of the controller.

In the first case, the control effects of different algorithms are compared under the standard conditions. The control effects of three algorithms are shown in FIG. 2 under the nominal conditions of flight height H=0, Ma=0, no noise and no delay. It can be seen that the rise time of MFAC+Kp algorithm is between MFAC and PID algorithm, but the advantage over MFAC algorithm lies in smaller overshoot, which satisfies the strict stability requirement of the control algorithm for the performance.

The second case is used to illustrate that the controller can adaptively control a broad flight envelope of the aircraft. The control effects are analyzed at different flight heights. The results are shown in FIG. 3. From the simulation results, MFAC+Kp algorithm can realize stable control for different flight heights. The higher the flight height, the greater the overshoot, but the algorithm can still stabilize the system output quickly with strong adaptive ability. In addition, compared with MFAC control effect under the same conditions, the control algorithm has stronger stability.

The third case is used to verify the stable control for the model by the control algorithm under the condition of delay. Four different delay values are selected to simulate under the flight conditions of H=10 and Ma=1. The results show that MFAC+Kp algorithm can implement control stably and quickly pointing at different degrees of delay. It can be seen from FIG. 4 that when the actuator is saturated, the proposed anti-windup algorithm can make the model get rid of a saturated region quickly, but the MFAC algorithm takes a long time to get rid of the saturated region under the same conditions, because of continued operation after saturation.

The present invention has the following beneficial effects:

(1) The CFDL-MFAC+Kp control algorithm improves the response speed and robustness of the original MFAC, and conducts theoretical analysis on the basis of the existing MFAC proof of stability to prove the stability of the improved algorithm.

(2) Under the above control algorithm structure, the anti-windup algorithm of the actuator is integrated and taken into account at the same time, and the anti-windup effect of the above control algorithm is verified by experimental analysis.

### DESCRIPTION OF DRAWINGS

FIG. 1 is a structural diagram of a controller.

FIG. 2 is an effect comparison diagram of three control algorithms of MFAC+Kp, MFAC and PID.

FIG. 3 shows comparison of control effects at different flight heights.

FIG. 4 shows comparison of control effects at different delays.

### DETAILED DESCRIPTION

To make the proposed technical solutions and the technical problems solved by the present invention more clear, the technical solutions of the present invention are illustrated in detail below in combination with the drawings.

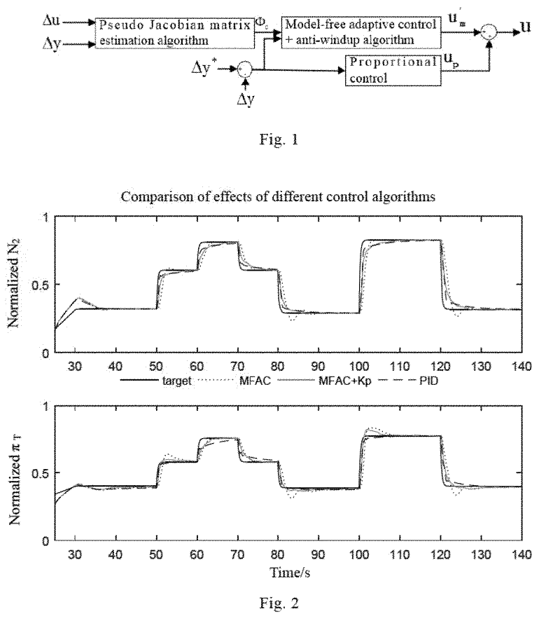

A structural block diagram of the improved control algorithm of the present invention is shown in FIG. 1. The controller mainly comprises three parts: MFAC, proportional control and anti-windup control. The control algorithm combines the advantages of three algorithms, can realize stable and quick control even for a very complex nonlinear model and has good robustness.

The specific composition of all parts of the control algorithm is as follows:

(1) MFAC algorithm: at each sampling time point, the parameters of the control algorithm are updated by the estimation algorithm, so that the control algorithm can be changed adaptively to achieve a good control effect on a control object, with certain robustness. However, due to the addition of the estimation algorithm, the response time of the controller becomes slow and easily affected by disturbance. In order to satisfy the requirements for the rapidity and the robustness of the controller, a proportional control link is considered to be added on the basis of the control algorithm.

(2) Proportional control algorithm: this algorithm is simple in operation and short in time consumption, reduces steady-state errors, accelerates control response, makes up for the deficiency of MFAC algorithm and improves the control performance.

(3) Anti-windup algorithm: due to the upper and lower limits of the actuator in the control system, the output of the control algorithm may exceed the executive capacity of the actuator, making the actuator fall into saturation, which will affect the response speed and control accuracy of the controller. The anti-windup algorithm can stop operation when the actuator reaches saturation, so that when the control algorithm provides a normal instruction, the actuator can respond as quickly as when the actuator is not saturated.

The basic standard for measuring the control algorithm is the accuracy, stability and rapidity of control. The present invention also has anti-windup performance while satisfying the above standard. The improved model-free adaptive control method of the present invention mainly has the following advantages:

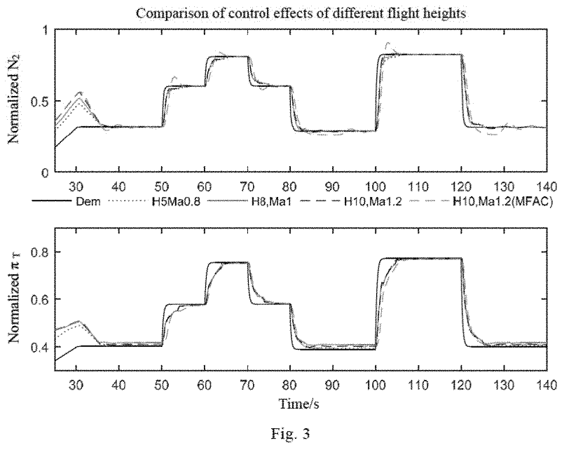

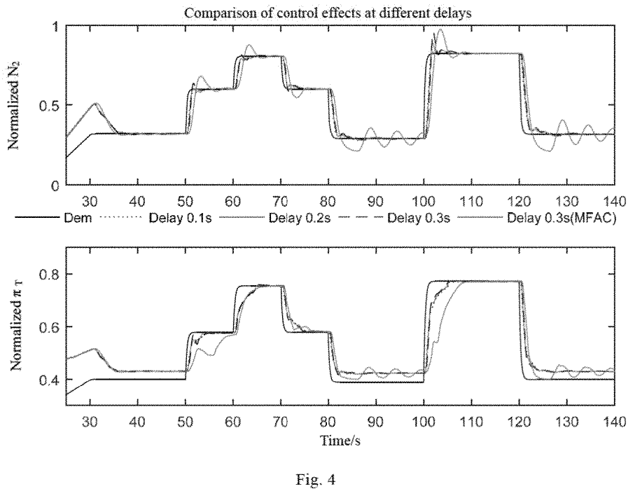

(1) Good accuracy. It can be seen from FIG. 3 and FIG. 4 that the control algorithm in the present invention can achieve good control effects at different heights and different delays, which indicates that the algorithm has good accuracy.

(2) Excellent stability. It can be seen from FIG. 2, FIG. 3 and FIG. 4 that by comparing with MFAC and PID algorithms under the same conditions, the control algorithm in the present invention has excellent stability, and can realize stable control at different flight heights and different delays, and the stability is obviously better than the original MFAC algorithm.

(3) Excellent rapidity. It can be seen from FIG. 3 and FIG. 4 that by comparing with MFAC and PID algorithms under the same conditions, the control algorithm in the present invention has excellent rapidity, and can realize stable control at different flight heights and different delays, and the stability is obviously better than the original MFAC algorithm.

(4) Good anti-windup performance. It can be seen from FIG. 4 that the anti-windup algorithm in the present invention may stop accumulating after the actuator is saturated to prevent further saturation. After the controller outputs a normal value, the actuator can respond quickly, and the response speed is higher than that of the original MFAC algorithm.

The improved model-free adaptive control method proposed in the present invention is provided below, which comprises the following specific steps:

step A: analyzing the existing method for the compact dynamic linearization model-free adaptive control, and from experimental results, finding that the application process has deficiencies in response time and stability;

expressing MIMO discrete-time nonlinear systems as follows:

y(k+1)=f(y(k), . . . ,y(k−n_{y}),u(k), . . . ,u(k−nᵤ)) (1)

wherein u(k) and y(k) are system inputs and system outputs at time k, respectively; n_{y} and nᵤ are two unknown integers; f( . . . )=(f₁( . . . ), . . . , fₘ( . . . )) is an unknown nonlinear function;

when f has a continuous partial derivative condition and formula (1) satisfies a generalized Lipschitz condition, expressing formula (1) as the following CFDL data model form:

$$Δ y ( k + 1 ) = {Φ}_{c} ( k ) Δ u ( k ) wherein \qquad ( 2 )$$

$${Φ}_{c} ( k ) = [ \begin{matrix}{ϕ}_{11} ( k ) & {ϕ}_{12} ( k ) & … & {ϕ}_{1 m} ( k ) \\ {ϕ}_{21} ( k ) & {ϕ}_{22} ( k ) & … & {ϕ}_{2 m} ( k ) \\ ⋮ & ⋮ & ⋮ & ⋮ \\ {ϕ}_{m 1} ( k ) & {ϕ}_{m 2} ( k ) & … & {ϕ}_{m m} ( k )\end{matrix} ] ∈ {R}^{m \times m} ;$$

firstly, proposing the following assumptions:

assumption 1: Φ_{c}(k) as a pseudo Jacobian matrix of the system shall be a diagonal dominant matrix which satisfies the following conditions: |ϕᵢⱼ|≤b₁,b₂≤|ᵢᵢ(k)|≤αb₂,α≥1,b₂>b₁(2α+1)(m−1), i=1, . . . ,m, j=1, . . . ,m, i≠j; b₁ and b₂ are set as bounded constants, i and j are set as row and column indexes of the matrix; and the signs of all elements in Φ_{c}(k) remain the same at any time k;

expressing a control input criterion function as formula (3):

J(u(k))=∥y*(k+1)−y(k+1)∥²+λ∥u(k)−u(k−1)∥² (3)

wherein λ>0 represents a weight factor, which is used to punish the change of excessive control input quantity; y*(k+1) is a desired output signal;

substituting formula (2) into formula (3), deriving u(k) and making the equation equal to zero to obtain a control input algorithm as follows:

$$u ( k ) = u ( k - 1 ) + \frac{{ρΦ}_{c}^{T} ( k ) ( {y}^{*} ( k + 1 ) - y ( k ) )}{λ + {‖ {Φ}_{c} ( k ) ‖}^{2}} \qquad ( 4 )$$

considering the following parameter estimation criteria function:

J(Φ_{c}(k))=∥Δy(k)−Φ_{c}(k)Δu(k−1)∥²+μ∥Φ_{c}(k)−\hat{Φ}_{c}(k−1)∥² (5)

wherein μ is a weight factor used to punish excessive changes in PJM estimates; \hat{Φ}_{c}(k) is an estimate of Φ_{c}(k);

deriving Φ_{c}(k) in formula (5) and making the equation equal to zero to obtain a parameter estimation algorithm as follows:

$${\hat{Φ}}_{c} ( k ) = {\hat{Φ}}_{c} ( k - 1 ) + \frac{\begin{matrix}η ( Δ y ( k ) - {\hat{Φ}}_{c} ( k - 1 ) Δ u ( k - 1 ) ) \\ Δ {u}^{T} ( k - 1 )\end{matrix}}{μ {‖ Δ u ( k - 1 ) ‖}^{2}} \qquad ( 6 )$$

conducting parameter estimation in each k by the above control parameter estimation algorithm to provide control inputs at the time; however, the calculation of the parameter estimation algorithm needs to occupy a certain time, causing slow system response and causing the control algorithm to be limited in use for a system with a small requirement for a control period; and the system vibrates greatly under non-ideal conditions from the experimental results;

step B: based on the above problems of slow response and vibration, considering the following improved solution;

Δu(k)=Δuₘ(k)′+Δuₚ(k) (7)

wherein uₘ(k)′ is MFAC controller output, and Δuₚ(k) is proportional controller output expressed by the following formulas:

$$Δ {u}_{m} ( k ) = \frac{{ρΦ}_{c}^{T} ( k ) ( {y}^{*} ( k + 1 ) - y ( k ) )}{λ + {‖ {Φ}_{c} ( k ) ‖}^{2}} \qquad ( 8 )$$

$$Δ {u}_{p} ( k ) = β K ( {y}^{*} ( k + 1 ) - y ( k ) ) - β K ( {y}^{*} ( k ) - y ( k - 1 ) ) \qquad ( 9 )$$

proposing the following control solution based on formulas (6) and (7):

$${\hat{ϕ}}_{ii} ( k ) = {\hat{ϕ}}_{ii} ( 1 ) , if \vert {\hat{ϕ}}_{ii} ( k ) \vert < {b}_{2} or \vert {\hat{ϕ}}_{ii} ( k ) \vert > α {b}_{2} or \qquad ( 10 )$$

$$sign ( {\hat{ϕ}}_{ii} ( k ) ) \neq sign ( {\hat{ϕ}}_{ii} ( 1 ) ) i = 1 , … , m$$

$${\hat{ϕ}}_{ij} ( k ) = {\hat{ϕ}}_{ij} ( 1 ) , if \vert {\hat{ϕ}}_{ij} ( k ) \vert > {b}_{1} or sign ( {\hat{ϕ}}_{ij} ( k ) ) \neq sign ( {\hat{ϕ}}_{ij} ( 1 ) ) , i \neq j \qquad ( 11 )$$

$$u ( k ) = u ( k - 1 ) + \frac{{ρΦ}_{c}^{T} ( k ) ( {y}^{*} ( k + 1 ) - y ( k ) )}{λ + {‖ {Φ}_{c} ( k ) ‖}^{2}} f ( k ) + β K ( {y}^{*} ( k + 1 ) - y ( k ) ) - β K ( {y}^{*} ( k ) - y ( k - 1 ) ) \qquad ( 12 )$$

wherein \hat{ϕ}ᵢⱼ(1) is an initial value of \hat{ϕ}ᵢⱼ(k), i=1, . . . , m; j=1, . . . , m;

proposing the following anti-windup algorithm as part of the proposed control algorithm: stopping updating an integrator when an actuator is at an upper saturation limit and there is still a growing trend, or when the actuator is at a lower saturation limit and is still decreasing; otherwise, the integrator works normally; that is, in the case of saturation, only the integral operations that help to reduce the degree of saturation are performed, and expressed by the following formulas:

$$Δ {{u}_{m} ( k )}^{′} = Δ {u}_{m} ( k ) f ( k ) \qquad ( 13 )$$

$$f ( k ) = \{ \begin{matrix}0 , & \begin{matrix}u ( k ) > u\_max ⋀ Δ u ( k ) > 0 , \\ u ( k ) < u\_min ⋀ Δ u ( k ) < 0\end{matrix} \\ 1 , & otherwise\end{matrix} \qquad ( 14 )$$

wherein u_max and u_min are the upper and lower limits of the actuator;

step C: for the above improved control algorithm, analyzing the convergence of tracking error and the stability of bounded input and bounded output through theoretical derivation;

firstly, defining the following output errors of the system:

e(k)=y*(k)−y(k) (15)

substituting formula (2) and formula (14) into formula (15), and when f(k)=1, obtaining:

$$\begin{matrix}e ( k + 1 ) = e ( k ) - {Φ}_{c} ( k ) Δ u ( k ) \\ = [ I - ( \frac{{ρΦ}_{c} ( k ) {\hat{Φ}}_{c}^{T} ( k )}{λ + {‖ {\hat{Φ}}_{c} ( k ) ‖}^{2}} + β {Φ}_{c} ( k ) K ) ] \\ e ( k ) + β {Φ}_{c} ( k ) K e ( k - 1 )\end{matrix} \qquad ( 16 )$$

$${D}_{j} = \{ z ‖ z - \vert 1 - ( \frac{ρ {\sum }_{i = 1}^{m} {ϕ}_{ji} ( k ) {\hat{ϕ}}_{ji} ( k )}{λ + {‖ \hat{Φ} ( k ) ‖}^{2}} + β {ϕ}_{jj} ( k ) {K}_{jj} ) ‖ \leq {\sum }_{l = 1 , l \neq j}^{m} \vert \frac{ρ {\sum }_{i = 1}^{m} {ϕ}_{ji} ( k ) {\hat{ϕ}}_{li} ( k )}{λ + {‖ \hat{Φ} ( k ) ‖}^{2}} + {\sum }_{i = 1}^{m} β {ϕ}_{ji} ( k ) {K}_{il} \vert \} , \qquad ( 17 )$$

wherein z is a characteristic value of matrix I−(ρΦ_{c}(k)\hat{Φ}_{c}^{T}(k)/(λ+∥\hat{Φ}_{c}(k)∥²)+βΦ_{c}(k)K) and Dⱼ, j=1, 2, . . . , m is a Gershgorin disk;

formula (17) is equivalent to formula (18);

$${D}_{j} = \{ z \vert \vert z \vert \leq \vert 1 - ( \frac{ρ {\sum }_{i = 1}^{m} {ϕ}_{ji} ( k ) {\hat{ϕ}}_{ji} ( k )}{λ + {‖ \hat{Φ} ( k ) ‖}^{2}} + β {ϕ}_{jj} ( k ) {K}_{jj} ) ‖ + {\sum }_{l = 1 , l \neq j}^{m} \vert \frac{ρ {\sum }_{i = 1}^{m} {ϕ}_{ji} ( k ) {\hat{ϕ}}_{li} ( k )}{λ + {‖ \hat{Φ} ( k ) ‖}^{2}} + {\sum }_{i = 1}^{m} β {ϕ}_{ji} ( k ) {K}_{il} \vert \} \qquad ( 18 )$$

by resetting algorithms (12) and (13), obtaining |\hat{ϕ}ᵢⱼ|≤b₁ and b₂≤|\hat{ϕ}ᵢᵢ(k)|≤αb₂, i=1, . . . ,m; j=1, . . . ,m; i≠j; from assumption 1, obtaining |ϕᵢⱼ|≤b₁,b₂≤|ϕᵢᵢ(k)|≤αb₂, i=1, . . . ,m; j=1, . . . ,m; i≠j;

from the above conditions, obtaining the following inequalities

$$1 - ( \frac{ρ {\sum }_{i = 1}^{m} \vert {ϕ}_{ji} ( k ) {\hat{\vert \vert ϕ}}_{ji} ( k ) \vert}{λ + {‖ \hat{Φ} ( k ) ‖}^{2}} + β {ϕ}_{jj} ( k ) {K}_{jj} ) \leq 1 - ( \frac{ρ \vert {ϕ}_{jj} ( k ) \vert \vert {\hat{ϕ}}_{jj} ( k ) \vert}{λ + {‖ \hat{Φ} ( k ) ‖}^{2}} + {βϕ}_{jj} ( k ) {K}_{jj} ) \leq 1 - ( \frac{ρ {b}_{2}^{2}}{λ + {‖ \hat{Φ} ( k ) ‖}^{2}} + β {K}_{min} {b}_{2} ) \qquad ( 19 )$$

$${\sum }_{l = 1 , l \neq j}^{m} \vert \frac{ρ {\sum }_{i = 1}^{m} {ϕ}_{ji} ( k ) {\hat{ϕ}}_{li} ( k )}{λ + {‖ \hat{Φ} ( k ) ‖}^{2}} + {\sum }_{i = 1}^{m} β {ϕ}_{ji} ( k ) {K}_{il} \vert \leq ρ {\sum }_{l = 1 , i \neq j}^{m} \frac{{\sum }_{i = 1}^{m} \vert {ϕ}_{ji} ( k ) \vert \vert {\hat{ϕ}}_{li} ( k ) \vert}{λ + {‖ \hat{Φ} ( k ) ‖}^{2}} + {\sum }_{l = 1 , i \neq j}^{m} β \vert {ϕ}_{ji} ( k ) \vert {K}_{li} = ρ \frac{{\sum }_{i = 1 , l \neq j}^{m} \vert {ϕ}_{jj} ( k ) \vert \vert {\hat{ϕ}}_{lj} ( k ) \vert}{λ + {‖ \hat{Φ} ( k ) ‖}^{2}} + ρ \frac{{\sum }_{i = 1 , l \neq j}^{m} \vert {ϕ}_{ji} ( k ) \vert \vert {\hat{ϕ}}_{il} ( k ) \vert}{λ + {‖ \hat{Φ} ( k ) ‖}^{2}} + ρ \frac{{\sum }_{l = 1 , l \neq j}^{m} {\sum }_{i = 1 , i \neq j , l}^{m} \vert {ϕ}_{ji} ( k ) \vert \vert {\hat{ϕ}}_{li} ( k ) \vert}{λ + {‖ \hat{Φ} ( k ) ‖}^{2}} + {\sum }_{i = 1 , i \neq j}^{m} β \vert {ϕ}_{ji} ( k ) \vert {K}_{ii} \leq ρ \frac{\begin{matrix}2 α {b}_{1} {b}_{2} ( m - 1 ) + \\ {b}_{1}^{2} ( m - 1 ) ( m - 2 )\end{matrix}}{λ + {‖ \hat{Φ} ( k ) ‖}^{2}} + β {K}_{max} {b}_{1} ( m - 1 ) . \qquad ( 20 )$$

$$1 - ( \frac{ρ {\sum }_{i = 1}^{m} \vert {ϕ}_{ji} ( k ) \vert \vert {\hat{ϕ}}_{ji} ( k ) \vert}{λ + {‖ \hat{Φ} ( k ) ‖}^{2}} + β {ϕ}_{jj} ( k ) {K}_{jj} ) + {\sum }_{l = 1 , l \neq j}^{m} \vert \frac{{\sum }_{i = 1}^{m} {ϕ}_{ji} ( k ) {\hat{ϕ}}_{li} ( k )}{λ + {‖ \hat{Φ} ( k ) ‖}^{2}} + β {ϕ}_{ji} ( k ) {K}_{il} \vert \leq 1 - [ \begin{matrix}ρ \frac{{b}_{2}^{2} - 2 α {b}_{1} {b}_{2} ( m - 1 ) - {b}_{1}^{2} ( m - 1 ) ( m - 2 )}{λ + {‖ \hat{Φ} ( k ) ‖}^{2}} + \\ β {K}_{min} ( {b}_{2} - {b}_{1} ( m - 1 ) )\end{matrix} ] = 1 - [ \begin{matrix}ρ \frac{{b}_{2} ( {b}_{2} - 2 α {b}_{1} ( m - 1 ) ) - {b}_{1}^{2} ( m - 1 ) ( m - 2 )}{λ + {‖ \hat{Φ} ( k ) ‖}^{2}} + \\ β {K}_{min} ( {b}_{2} - {b}_{1} ( m - 1 ) )\end{matrix} ] < 1 - [ \begin{matrix}ρ \frac{{b}_{2} {b}_{1} ( m - 1 ) - {b}_{1}^{2} ( m - 1 ) ( m - 2 )}{λ + {‖ \hat{Φ} ( k ) ‖}^{2}} + \\ β {K}_{min} ( {b}_{2} - {b}_{1} ( m - 1 ) )\end{matrix} ] < 1 - [ \begin{matrix}ρ \frac{{b}_{2} {b}_{1} ( m - 1 ) - {b}_{1}^{2} ( m - 1 ) ( m - 1 )}{λ + {‖ \hat{Φ} ( k ) ‖}^{2}} + \\ β {K}_{min} ( {b}_{2} - {b}_{1} ( m - 1 ) )\end{matrix} ] = 1 - [ \begin{matrix}ρ \frac{{b}_{1} ( m - 1 ) ( {b}_{2} - {b}_{1} ( m - 1 )}{λ + {‖ \hat{Φ} ( k ) ‖}^{2}} + \\ β {K}_{min} ( {b}_{2} - {b}_{1} ( m - 1 ) )\end{matrix} ] < 1 - [ ρ \frac{2 α {{b}_{1}^{2} ( m - 1 )}^{2}}{λ + {‖ \hat{Φ} ( k ) ‖}^{2}} + 2 β {K}_{min} α {b}_{1} ( m - 1 ) ] \qquad ( 21 )$$

by resetting algorithm formula (11) and assumption 1, obtaining \hat{ϕ}ⱼᵢ(k)ϕⱼᵢ(k)>0, i=1, . . . ,m; j=1, . . . ,m; therefore, there is a λₘᵢₙ, so that when λ>λₘᵢₙ, the following equality holds:

$$\frac{ρ {\sum }_{i = 1}^{m} {ϕ}_{ji} ( k ) {\hat{ϕ}}_{ji} ( k )}{λ + {‖ \hat{Φ} ( k ) ‖}^{2}} + β {ϕ}_{jj} ( k ) {K}_{jj} = \frac{ρ {\sum }_{i = 1}^{m} \vert {ϕ}_{ji} ( k ) {\hat{\vert \vert ϕ}}_{ji} ( k )}{λ + {‖ \hat{Φ} ( k ) ‖}^{2}} + β {ϕ}_{jj} ( k ) {K}_{jj} \leq ρ \frac{{α}^{2} {b}_{2}^{2} + {b}_{1}^{2} ( m - 1 )}{λ + {‖ \hat{Φ} ( k ) ‖}^{2}} + βα {b}_{2} {K}_{max} < ρ \frac{{α}^{2} {b}_{2}^{2} + {b}_{1}^{2} ( m - 1 )}{{λ}_{min} + {‖ \hat{Φ} ( k ) ‖}^{2}} + β {αb}_{2} {K}_{max} < 1 \qquad ( 22 )$$

thus, selecting 0<ρ≤1 and λ>λₘᵢₙ such that

$$\vert 1 - ( \frac{ρ {\sum }_{i = 1}^{m} {ϕ}_{ji} ( k ) {\hat{ϕ}}_{ji} ( k )}{λ + {‖ \hat{Φ} ( k ) ‖}^{2}} + {βϕ}_{jj} ( k ) {K}_{jj} ) \vert = 1 - ( \frac{ρ {\sum }_{i = 1}^{m} {ϕ}_{ji} ( k ) {\hat{ϕ}}_{ji} ( k )}{λ + {‖ \hat{Φ} ( k ) ‖}^{2}} + {βϕ}_{jj} ( k ) {K}_{jj} ) \qquad ( 23 )$$

for any λ>λₘᵢₙ, the following inequalities hold obviously

$$0 < {M}_{1} \leq ρ \frac{2 α {{b}_{1}^{2} ( m - 1 )}^{2}}{λ + {‖ \hat{Φ} ( k ) ‖}^{2}} + 2 β {K}_{min} α {b}_{1} ( m - 1 ) < \frac{{b}_{2}^{2}}{λ + {‖ \hat{Φ} ( k ) ‖}^{2}} + 2 β {K}_{min} α {b}_{1} ( m - 1 ) \leq \frac{{α}^{2} {b}_{2}^{2} + {b}_{1}^{2} ( m - 1 )}{λ + {‖ \hat{Φ} ( k ) ‖}^{2}} + 2 β {K}_{min} α {b}_{1} ( m - 1 ) < \frac{{α}^{2} {b}_{2}^{2} + {b}_{1}^{2} ( m - 1 )}{{λ}_{min} + {‖ \hat{Φ} ( k ) ‖}^{2}} + 2 β {K}_{min} α {b}_{1} ( m - 1 ) < 1 \qquad ( 24 )$$

from formulas (21), (23) and (24), knowing

$$\vert 1 - ( \frac{ρ {\sum }_{i = 1}^{m} {ϕ}_{ji} ( k ) {\hat{ϕ}}_{ji} ( k )}{λ + {‖ \hat{Φ} ( k ) ‖}^{2}} + β {ϕ}_{jj} ( k ) {K}_{jj} ) \vert + {\sum }_{l = 1 , l \neq j}^{m} \vert \frac{ρ {\sum }_{i = 1}^{m} {ϕ}_{ji} ( k ) {\hat{ϕ}}_{ji} ( k ) x}{λ + {‖ \hat{Φ} ( k ) ‖}^{2}} + β {\hat{ϕ}}_{ji} ( k ) {K}_{il} \vert < 1 - {M}_{1} < 1 \qquad ( 25 )$$

from formulas (18) and (24), obtaining

$$s [ I - ( \frac{ρ {Φ}_{c} ( k ) {\hat{Φ}}_{c}^{T} ( k )}{λ + {‖ \hat{Φ} ( k ) ‖}^{2}} + β {Φ}_{c} ( k ) K ) ] \leq 1 - {M}_{1} \qquad ( 26 )$$

wherein s(M) is the spectral radius of matrix M;
letting

$$A = {‖ I - ( \frac{ρ {Φ}_{c} ( k ) {\hat{Φ}}_{c}^{T} ( k )}{λ + {‖ \hat{Φ} ( k ) ‖}^{2}} + β {Φ}_{c} ( k ) K ‖}_{v}$$

and B=∥βΦ_{c}(k)K)∥ᵥ; from the conclusion of the spectral radius of the matrix, an any small positive number ε₁ exists, such that

$$A \leq s [ I - ( \frac{ρ {Φ}_{c} ( k ) {Φ}_{c}^{T} ( k )}{λ + {‖ \hat{Φ} ( k ) ‖}^{2}} + β {Φ}_{c} ( k ) K ) ] + {ε}_{1} \leq 1 - {M}_{1} + {ε}_{1} < 1 \qquad ( 27 )$$

wherein ∥M∥ᵥ is the compatible norm of matrix M;

β exists such that B satisfies the following inequality:

1>1−A≤M₁−ε₁>B>0 (28)

from formulas (16) and (28), obtaining:

∥e(k+1)∥ᵥ≤A∥e(k)∥ᵥ+B∥e(k−1)∥ᵥ<(1−B)∥e(k)∥ᵥ+B∥e(k−1)∥ᵥ (29)

after transposition, obtaining:

∥e(k+1)∥ᵥ−∥e(k)∥ᵥ<−B(∥e(k)∥ᵥ−∥e(k−1)∥ᵥ) (30)

based on formula (30), discussing the form of e(k) from the following four aspects:

1. when ∥e(k+1)∥ᵥ>∥e(k)∥ᵥ and ∥e(k)∥ᵥ>∥e(k−1)∥ᵥ, obtaining

∥e(k+1)∥ᵥ−∥e(k)∥ᵥ>−B(∥e(k)∥ᵥ−∥e(k−1)∥ᵥ) (31)

which is the opposite of formula (30); therefore, this assumption does not exist;
2. when ∥e(k+1)∥ᵥ>∥e(k)∥ᵥ and ∥e(k)∥ᵥ<∥e(k−1)∥ᵥ from formula (30), obtaining:

$$\frac{{‖ e ( k + 1 ) ‖}_{v} - {‖ e ( k ) ‖}_{v}}{{‖ e ( k - 1 ) ‖}_{v} - {‖ e ( k ) ‖}_{v}} < B < 1 \qquad ( 32 )$$

i.e., the decrease of e(k) is larger than the increase in three adjacent sampling points; and as a result, the overall trend is decreasing under this situation;
3. when ∥e(k+1)∥ᵥ<∥e(k)∥ᵥ and ∥e(k)∥ᵥ<∥e(k−1)∥ᵥ, obtaining

$$\frac{{‖ e ( k + 1 ) ‖}_{v}}{{‖ e ( k ) ‖}_{v}} < 1 and \frac{{‖ e ( k ) ‖}_{v}}{{‖ e ( k - 1 ) ‖}_{v}} < 1 \qquad ( 33 )$$

which satisfies formula (30), and e(k) has a decreasing trend in this case;
4. when ∥e(k+1)∥ᵥ<∥e(k)∥ᵥ and ∥e(k)∥ᵥ>∥e(k−1)∥ᵥ, according to formula (30), this situation may exist; two possibilities exist in the time of k+2 in detail: if ∥e(k+2)∥ᵥ>∥e(k+1)∥ᵥ exists, obtaining the same conclusion as the second case; if ∥e(k+2)∥ᵥ<∥e(k+1)∥ᵥ, obtaining the same conclusion as the third case; in short, e(k) still has a decreasing trend in this case;

the above methods of proof are also applicable when f(k)=0; to sum up, the overall trend of error e(k) is decreasing; therefore, the convergence of the error is proved;

step D: applying the above control algorithm to control of an aero-engine model, and selecting three different cases for result comparison to verify the effectiveness and superiority of the control algorithm; firstly, comparing the control effects of MFAC+Kp, CFDL-MFAC and PID under the standard conditions to illustrate the effectiveness of an improved controller; and then, comparing the control effects at different heights and different delays to illustrate the superiority of the controller.

In the first case, the control effects of different algorithms are compared under the standard conditions. The control effects of three algorithms are shown in FIG. 2 under the nominal conditions of flight height H=0, Ma=0, no noise and no delay. It can be seen that the rise time of MFAC+Kp algorithm is between MFAC and PID algorithm, but the advantage over MFAC algorithm lies in smaller overshoot, which satisfies the strict stability requirement of the control algorithm for the performance.

The second case is used to illustrate that the controller can adaptively control a broad flight envelope of the aircraft. The control effects are analyzed at different flight heights. The results are shown in FIG. 3. From the simulation results, MFAC+Kp algorithm can realize stable control for different flight heights. The higher the flight height, the greater the overshoot, but the algorithm can still stabilize the system output quickly with strong adaptive ability. In addition, compared with MFAC control effect under the same conditions, the control algorithm has stronger stability.

The third case is used to verify the stable control for the model by the control algorithm under the condition of delay. Four different delay values are selected to simulate under the flight conditions of H=10 and Ma=1. The results show that MFAC+Kp algorithm can implement control stably and quickly pointing at different degrees of delay. It can be seen from FIG. 4 that when the actuator is saturated, the proposed anti-windup algorithm can make the model get rid of a saturated region quickly, but the MFAC algorithm takes a long time to get rid of the saturated region under the same conditions, because of continued operation after saturation.

In conclusion, the improved model-free adaptive control method of the present invention proposes a new model-free adaptive control method which improves the overshoot oscillation of MFAC by adding proportional control. At the same time, the present invention integrates the idea of integral anti-windup to improve the control performance. It is proved through strict analysis that the improved control algorithm has tracking error convergence and BIBO stability under the condition of satisfying the assumption. Finally, the improved MFAC is applied to the control of the aero-engine model. Three experiments are carried out from different perspectives to verify the anti-windup performance, rapidity and stability of the control algorithm of the present invention at different flight heights and different delays. The results are superior to the MFAC algorithm and the PID algorithm. The results show that the control algorithm proposed herein has stable and quick control effects on the aero-engine control system and the effectiveness of the algorithm is verified.

It should be noted that those skilled in the art should understand that the above embodiments are only used for illustrating the technical solutions of the present invention, rather than limiting the present invention. Different technical features that appear in different embodiments can be combined to obtain beneficial effects. On the basis of the description and the claims, the researchers in the art shall understand and realize other varied embodiments of disclosed embodiments in combination with the drawings. It should be noted that the present invention is described in detail by referring to the above embodiments, and the amendments to the technical solution mentioned in each of the above embodiments or the equivalent replacements for part of or all the technical features therein do not enable the essence of the corresponding technical solution to depart from the scope of the technical solution of various embodiments of the present invention.

1. An improved model-free adaptive control method, comprising steps of:
step A: analyzing the existing method for the compact dynamic linearization model-free adaptive control, and from experimental results, finding that the application process has deficiencies in response time and stability;
expressing MIMO discrete-time nonlinear systems as follows:
y(k+1)=f(y(k), . . . ,y(k−n_{y}),u(k), . . . ,u(k−nᵤ)) (1)
wherein u(k) and y(k) are system inputs and system outputs at time k, respectively; n_{y} and nᵤ are two unknown integers; f( . . . )=(f₁( . . . ), . . . , fₘ( . . . )) is an unknown nonlinear function;
when f has a continuous partial derivative condition and formula (1) satisfies a generalized Lipschitz condition, expressing formula (1) as the following CFDL data model form:
$$Δ y ( k + 1 ) = {Φ}_{c} ( k ) Δ u ( k ) wherein \qquad ( 2 )$$
$${Φ}_{c} ( k ) = [ \begin{matrix}{ϕ}_{11} ( k ) & {ϕ}_{12} ( k ) & … & {ϕ}_{1 m} ( k ) \\ {ϕ}_{21} ( k ) & {ϕ}_{22} ( k ) & … & {ϕ}_{2 m} ( k ) \\ ⋮ & ⋮ & ⋮ & ⋮ \\ {ϕ}_{m 1} ( k ) & {ϕ}_{m 2} ( k ) & … & {ϕ}_{m m} ( k )\end{matrix} ] ∈ {R}^{m \times m} ;$$
firstly, proposing the following assumptions:
assumption 1: Φ_{c}(k) as a pseudo Jacobian matrix of the system shall be a diagonal dominant matrix which satisfies the following conditions: |ϕᵢⱼ|≤b₁,b₂≤|ᵢᵢ(k)|≤αb₂,α≥1,b₂>b₁(2α+1)(m−1), i=1, . . . , m, j=1, . . . , m, i≠j; b₁ and b₂ are set as bounded constants, i and j are set as row and column indexes of the matrix; and the signs of all elements in Φ_{c}(k) remain the same at any time k;
expressing a control input criterion function as formula (3):
J(u(k))=∥y*(k+1)−y(k+1)∥²+λ∥u(k)−u(k−1)∥² (3)
wherein λ>0 represents a weight factor, which is used to punish the change of excessive control input quantity; y*(k+1) is a desired output signal;
substituting formula (2) into formula (3), deriving u(k) and making the equation equal to zero to obtain a control input algorithm as follows:
$$u ( k ) = u ( k - 1 ) + \frac{{ρΦ}_{c}^{T} ( k ) ( {y}^{*} ( k + 1 ) - y ( k ) )}{λ + {‖ {Φ}_{c} ( k ) ‖}^{2}} \qquad ( 4 )$$
considering the following parameter estimation criteria function:
J(Φ_{c}(k))=∥Δy(k)−Φ_{c}(k)Δu(k−1)∥²+μ∥Φ_{c}(k)−\hat{Φ}_{c}(k−1)∥² (5)
wherein μ is a weight factor used to punish excessive changes in PJM estimates; \hat{Φ}_{c}(k) is an estimate of Φ_{c}(k);
deriving Φ_{c}(k) in formula (5) and making the equation equal to zero to obtain a parameter estimation algorithm as follows:
$${\hat{Φ}}_{c} ( k ) = {\hat{Φ}}_{c} ( k - 1 ) + \frac{η ( Δ y ( k ) - {\hat{Φ}}_{c} ( k - 1 ) Δ u ( k - 1 ) ) Δ {u}^{T} ( k - 1 )}{μ + {‖ Δ u ( k - 1 ) ‖}^{2}} \qquad ( 6 )$$
conducting parameter estimation in each k by the above control parameter estimation algorithm to provide control inputs at the time; however, the calculation of the parameter estimation algorithm needs to occupy a certain time, causing slow system response and causing the control algorithm to be limited in use for a system with a small requirement for a control period; and the system vibrates greatly under non-ideal conditions from the experimental results;
step B: based on the above problems of slow response and vibration, considering the following improved solution;
Δu(k)=Δuₘ(k)′+Δuₚ(k) (7)
wherein uₘ(k)′ is MFAC controller output, and Δuₚ(k) is proportional controller output expressed by the following formulas:
$$Δ {u}_{m} ( k ) = \frac{{ρΦ}_{c}^{T} ( k ) ( {y}^{*} ( k + 1 ) - y ( k ) )}{λ + {‖ {Φ}_{c} ( k ) ‖}^{2}} \qquad ( 8 )$$
$$Δ {u}_{p} ( k ) = β K ( {y}^{*} ( k + 1 ) - y ( k ) ) - β K ( {y}^{*} ( k ) - y ( k - 1 ) ) \qquad ( 9 )$$
proposing the following anti-windup algorithm as part of the proposed control algorithm: stopping updating an integrator when an actuator is at an upper saturation limit and there is still a growing trend, or when the actuator is at a lower saturation limit and is still decreasing; otherwise, the integrator works normally; that is, in the case of saturation, only the integral operations that help to reduce the degree of saturation are performed, and expressed by the following formulas:
$$Δ {{u}_{m} ( k )}^{′} = Δ {u}_{m} ( k ) f ( k ) \qquad ( 10 )$$
$$f ( k ) = \{ \begin{matrix}0 , & \begin{matrix}u ( k ) > u\_max ⋀ Δ u ( k ) > 0 , \\ u ( k ) < u\_min ⋀ Δ u ( k ) < 0\end{matrix} \\ 1 , & otherwise\end{matrix} \qquad ( 11 )$$
wherein u_max and u_min are the upper and lower limitations of the actuator;
proposing the following control solution based on formulas (6), (7), (8) and (9):
$${\hat{ϕ}}_{ii} ( k ) = {\hat{ϕ}}_{ii} ( 1 ) , if \vert {\hat{ϕ}}_{ii} ( k ) \vert < {b}_{2} or \vert {\hat{ϕ}}_{ii} ( k ) \vert > α {b}_{2} or \qquad ( 12 )$$
$$sign ( {\hat{ϕ}}_{ii} ( k ) ) \neq sign ( {\hat{ϕ}}_{ii} ( 1 ) ) i = 1 , … , m$$
$${\hat{ϕ}}_{ij} ( k ) = {\hat{ϕ}}_{ij} ( 1 ) , if \vert {\hat{ϕ}}_{ij} ( k ) \vert > {b}_{1} or sign ( {\hat{ϕ}}_{ij} ( k ) ) \neq sign ( {\hat{ϕ}}_{ij} ( 1 ) ) , i \neq j \qquad ( 13 )$$
$$u ( k ) = u ( k - 1 ) + \frac{{ρΦ}_{c}^{T} ( k ) ( {y}^{*} ( k + 1 ) - y ( k ) )}{λ + {‖ {Φ}_{c} ( k ) ‖}^{2}} f ( k ) + β K ( {y}^{*} ( k + 1 ) - y ( k ) ) - β K ( {y}^{*} ( k ) - y ( k - 1 ) )$$
wherein \hat{ϕ}ᵢⱼ(1) is an initial value of \hat{ϕ}ᵢⱼ(k), i=1, . . . , m; j=1, . . . , m;
step C: for the above improved control algorithm, analyzing the convergence of tracking error and the stability of bounded input and bounded output through theoretical derivation;
firstly, defining the following output errors of the system:
e(k)=y*(k)−y(k) (15)
substituting formula (2) and formula (14) into formula (15), and when f(k)=1, obtaining:
$$\begin{matrix}e ( k + 1 ) = e ( k ) - {Φ}_{e} ( k ) Δ u ( k ) \\ = [ I - ( \frac{{ρΦ}_{e} ( k ) {\hat{Φ}}_{c}^{T} ( k )}{λ + {‖ {\hat{Φ}}_{c} ( k ) ‖}^{2}} + β {Φ}_{c} ( k ) K ) \\ e ( k ) + {βΦ}_{c} ( k ) Ke ( k - 1 )\end{matrix} \qquad ( 16 )$$
$${D}_{j} = \{ z ‖ z - \vert 1 - ( \frac{ρ {\sum }_{i = 1}^{m} {ϕ}_{ji} ( k ) {\hat{ϕ}}_{ji} ( k )}{λ + {‖ Φ ( k ) ‖}^{2}} + β {ϕ}_{jj} ( k ) {K}_{jj} ) ‖ \leq {{\sum }_{l = 1 , i \neq j}}^{m} \vert \frac{ρ {\sum }_{i = 1}^{m} {ϕ}_{ji} ( k ) {\hat{ϕ}}_{li} ( k )}{λ + {‖ \hat{Φ} ( k ) ‖}^{2}} + {\sum }_{i = 1}^{m} β {ϕ}_{ji} ( k ) {K}_{il} \vert \} \qquad ( 17 )$$
wherein z is a characteristic value of matrix I−(ρΦ_{c}(k)\hat{Φ}_{c}^{T}(k)/(λ+∥\hat{Φ}_{c}(k)∥²)+βΦ_{c}(k)K) and Dⱼ, j=1, 2, . . . , m is a Gershgorin disk;
formula (17) is equivalent to formula (18);
$${D}_{i} = \{ z ‖ z \vert \leq \vert 1 - ( \frac{ρ {\sum }_{i = 1}^{m} {ϕ}_{ji} ( k ) {\hat{ϕ}}_{ji} ( k )}{λ + {‖ \hat{Φ} ( k ) ‖}^{2}} + β {ϕ}_{jj} ( k ) {K}_{jj} ) \vert + {{\sum }_{l = 1 , i \neq j}}^{m} \vert \frac{ρ {\sum }_{i = 1}^{m} {ϕ}_{ji} ( k ) {\hat{ϕ}}_{li} ( k )}{λ + {‖ \hat{Φ} ( k ) ‖}^{2}} + {\sum }_{i = 1}^{m} β {ϕ}_{ji} ( k ) {K}_{il} \vert \} \qquad ( 18 )$$
by resetting algorithms (12) and (13), obtaining |\hat{ϕ}ᵢⱼ|≤b₁ and b₂≤|\hat{ϕ}ᵢᵢ(k)|≤αb₂, i=1, . . . ,m; j=1, . . . ,m; i≠j; from assumption 1, obtaining |ϕᵢⱼ|≤b₁,b₂≤|ϕᵢᵢ(k)|≤αb₂, i=1, . . . ,m; j=1, . . . ,m; i≠j;
from the above conditions, obtaining the following inequalities
$$1 - ( \frac{ρ {\sum }_{i = 1}^{m} \vert {ϕ}_{ji} ( k ) \vert \vert {\hat{ϕ}}_{ji} ( k ) \vert}{λ + {‖ \hat{Φ} ( k ) ‖}^{2}} + β {ϕ}_{jj} ( k ) {K}_{jj} ) \leq 1 - ( \frac{ρ \vert {ϕ}_{jj} ( k ) \vert \vert {\hat{ϕ}}_{jj} ( k ) \vert}{λ + {‖ \hat{Φ} ( k ) ‖}^{2}} + β {ϕ}_{jj} ( k ) {K}_{jj} ) \leq 1 - ( \frac{ρ {b}_{2}^{2}}{λ + {‖ \hat{Φ} ( k ) ‖}^{2}} + β {K}_{min} {b}_{2} ) \qquad ( 19 )$$
$$\begin{matrix}{{\sum }_{l = 1 , i \neq j}}^{m} \vert \frac{ρ {\sum }_{i = 1}^{m} {ϕ}_{ji} ( k ) {\hat{ϕ}}_{li} ( k ) \vert}{λ + {‖ \hat{Φ} ( k ) ‖}^{2}} + {\sum }_{i = 1}^{m} β {ϕ}_{ji} ( k ) {K}_{il} \vert \leq ρ {{\sum }_{l = 1 , i \neq j}}^{m} \frac{{\sum }_{i = 1}^{m} \vert {ϕ}_{ji} ( k ) \vert \vert {\hat{ϕ}}_{li} ( k ) \vert}{λ + {‖ \hat{Φ} ( k ) ‖}^{2}} + {{\sum }_{l = 1 , i \neq j}}^{m} β \vert {ϕ}_{jl} ( k ) \vert {K}_{il} = ρ \frac{{\sum }_{i = 1 , l \neq j}^{m} \vert {ϕ}_{ji} ( k ) \vert \vert {\hat{ϕ}}_{lj} ( k ) \vert}{λ + {‖ \hat{Φ} ( k ) ‖}^{2}} + ρ \frac{{\sum }_{i = 1 , l \neq j}^{m} \vert {ϕ}_{jl} ( k ) \vert \vert {\hat{ϕ}}_{li} ( k ) \vert}{λ + {‖ \hat{Φ} ( k ) ‖}^{2}} + ρ \frac{\begin{matrix}{\sum }_{l = 1 , l \neq j}^{m} {\sum }_{i = 1 , i \neq j , l}^{m} \\ \vert {ϕ}_{ji} ( k ) \vert \vert {\hat{ϕ}}_{li} ( k ) \vert\end{matrix}}{λ + {‖ \hat{Φ} ( k ) ‖}^{2}} + {{\sum }_{l = 1 , l \neq j}}^{m} β \vert {ϕ}_{jl} ( k ) \vert {K}_{il} \leq ρ \frac{\begin{matrix}2 α {b}_{1} {b}_{2} ( m - 1 ) + \\ {b}_{1}^{2} ( m - 1 ) ( m - 2 )\end{matrix}}{λ + {‖ \hat{Φ} ( k ) ‖}^{2}} + β {K}_{max} {b}_{1} ( m - 1 ) . & \end{matrix} \qquad ( 20 )$$
$$1 - ( \frac{ρ {\sum }_{i = 1}^{m} \vert {ϕ}_{ji} ( k ) \vert \vert {\hat{ϕ}}_{ji} ( k ) \vert}{λ + {‖ \hat{Φ} ( k ) ‖}^{2}} + β {ϕ}_{jj} ( k ) {K}_{jj} ) + {\sum }_{l = 1 , l \neq j}^{m} \vert \frac{{\sum }_{i = 1}^{m} {ϕ}_{ji} ( k ) {\hat{ϕ}}_{li} ( k )}{λ + {‖ \hat{Φ} ( k ) ‖}^{2}} + {βϕ}_{ji} ( k ) {K}_{il} \vert \leq 1 - [ \begin{matrix}ρ \frac{{b}_{2}^{2} - 2 α {b}_{1} {b}_{2} ( m - 1 ) - {b}_{1}^{2} ( m - 1 ) ( m - 2 )}{λ + {‖ \hat{Φ} ( k ) ‖}^{2}} + \\ β {K}_{min} ( {b}_{2} - {b}_{1} ( m - 1 ) )\end{matrix} ] = 1 - [ \begin{matrix}ρ \frac{{b}_{2} ( {b}_{2} - 2 α {b}_{1} ( m - 1 ) ) - {b}_{1}^{2} ( m - 1 ) ( m - 2 )}{λ + {‖ \hat{Φ} ( k ) ‖}^{2}} + \\ β {K}_{min} ( {b}_{2} - {b}_{1} ( m - 1 ) )\end{matrix} ] < 1 - [ \begin{matrix}ρ \frac{{b}_{2} {b}_{1} ( m - 1 ) - {b}_{1}^{2} ( m - 1 ) ( m - 2 )}{λ + {‖ \hat{Φ} ( k ) ‖}^{2}} + \\ β {K}_{min} ( {b}_{2} - {b}_{1} ( m - 1 ) )\end{matrix} ] < 1 - [ \begin{matrix}ρ \frac{{b}_{2} {b}_{1} ( m - 1 ) - {b}_{1}^{2} ( m - 1 ) ( m - 2 )}{λ + {‖ \hat{Φ} ( k ) ‖}^{2}} + \\ β {K}_{min} ( {b}_{2} - {b}_{1} ( m - 1 ) )\end{matrix} ] = 1 - [ ρ \frac{{b}_{1} ( m - 1 ) ( {b}_{2} - {b}_{1} ( m - 1 ) )}{λ + {‖ \hat{Φ} ( k ) ‖}^{2}} + β {K}_{min} ( {b}_{2} - {b}_{1} ( m - 1 ) ) ] < 1 - [ ρ \frac{2 α {{b}_{1}^{2} ( m - 1 )}^{2}}{λ + {‖ \hat{Φ} ( k ) ‖}^{2}} + 2 β {K}_{min} α {b}_{1} ( m - 1 ) ] \qquad ( 21 )$$
from resetting algorithm formula (11) and assumption 1, obtaining \hat{ϕ}ⱼᵢ(k)ϕⱼᵢ(k)>0, i=1, . . . , m; j=1, . . . , m; therefore, there is a λₘᵢₙ, so that when λ>λₘᵢₙ, the following equality holds:
$$\frac{ρ {\sum }_{i = 1}^{m} {ϕ}_{ji} ( k ) {\hat{ϕ}}_{ji} ( k )}{λ + {‖ \hat{Φ} ( k ) ‖}^{2}} + β {ϕ}_{jj} ( k ) {K}_{lj} = \frac{ρ {\sum }_{i = 1}^{m} \vert {ϕ}_{ji} ( k ) \vert \vert {\hat{ϕ}}_{ji} ( k ) \vert}{λ + {‖ \hat{Φ} ( k ) ‖}^{2}} = β {ϕ}_{jj} ( k ) {K}_{ji} \leq ρ \frac{{α}^{2} {b}_{2}^{2} + {b}_{1}^{2} ( m - 1 )}{λ + {‖ \hat{Φ} ( k ) ‖}^{2}} + β α {b}_{2} {K}_{max} < ρ \frac{{α}^{2} {b}_{2}^{2} + {b}_{1}^{2} ( m - 1 )}{{λ}_{min} + {‖ \hat{Φ} ( k ) ‖}^{2}} + β α {b}_{2} {K}_{max} < 1 \qquad ( 22 )$$
thus, selecting 0<ρ≤1 and λ>λₘᵢₙ such that
$$\vert 1 - ( \frac{ρ {\sum }_{i = 1}^{m} {ϕ}_{ji} ( k ) {\hat{ϕ}}_{ji} ( k )}{λ + {‖ \hat{Φ} ( k ) ‖}^{2}} + β {ϕ}_{jj} ( k ) {K}_{lj} ) \vert = 1 - ( \frac{ρ {\sum }_{i = 1}^{m} {ϕ}_{ji} ( k ) {\hat{ϕ}}_{ji} ( k )}{λ + {‖ \hat{Φ} ( k ) ‖}^{2}} + β {ϕ}_{jj} ( k ) {K}_{jj} ) \qquad ( 23 )$$
for any λ>λₘᵢₙ, the following inequalities hold obviously
$$0 < {M}_{1} \leq ρ \frac{2 α {{b}_{1}^{2} ( m - 1 )}^{2}}{λ + {‖ \hat{Φ} ( k ) ‖}^{2}} + 2 β {K}_{min} α {b}_{1} ( m - 1 ) < \frac{{b}_{2}^{2}}{λ + {‖ \hat{Φ} ( k ) ‖}^{2}} + 2 β {K}_{min} α {b}_{1} ( m - 1 ) \leq \frac{{α}^{2} {b}_{2}^{2} + {b}_{1}^{2} ( m - 1 )}{λ + {‖ \hat{Φ} ( k ) ‖}^{2}} + 2 β {K}_{min} α {b}_{1} ( m - 1 ) < \frac{{α}^{2} {b}_{2}^{2} + {b}_{1}^{2} ( m - 1 )}{{λ}_{min} + {‖ \hat{Φ} ( k ) ‖}^{2}} + 2 β {K}_{min} α {b}_{1} ( m - 1 ) < 1 \qquad ( 24 )$$
from formulas (21), (23) and (24), knowing
$$\vert 1 - ( \begin{matrix}\frac{ρ {\sum }_{i = 1}^{m} {ϕ}_{ji} ( k ) {\hat{ϕ}}_{ji} ( k )}{λ + {‖ \hat{Φ} ( k ) ‖}^{2}} + \\ β {ϕ}_{jj} ( k ) {K}_{jj}\end{matrix} ) \vert + {\sum }_{l = 1 , l \neq j}^{m} \vert \frac{ρ {\sum }_{i = 1}^{m} {ϕ}_{ji} ( k ) {\hat{ϕ}}_{li} ( k )}{λ + {‖ \hat{Φ} ( k ) ‖}^{2}} + β {ϕ}_{ji} ( k ) {K}_{il} \vert < 1 - {M}_{1} < 1 \qquad ( 25 )$$
from formulas (18) and (24), obtaining
$$s [ I - ( \frac{ρ {Φ}_{c} ( k ) {\hat{Φ}}_{c}^{T} ( k )}{λ + {‖ \hat{Φ} ( k ) ‖}^{2}} + β {Φ}_{c} ( k ) K ) ] \leq 1 - {M}_{1} \qquad ( 26 )$$
wherein s(M) is the spectral radius of matrix M;
letting
$$A = {‖ I - ( \frac{ρ {Φ}_{c} ( k ) {\hat{Φ}}_{c}^{T} ( k )}{λ + {‖ \hat{Φ} ( k ) ‖}^{2}} + β {Φ}_{c} ( k ) K ) ‖}_{v}$$
and B=∥βΦ_{c}(k)K)∥ᵥ; from the conclusion of the spectral radius of the matrix, an any small positive number ε₁ exists, such that
$$A \leq s [ I - ( \frac{ρ {Φ}_{c} ( k ) {\hat{Φ}}_{c}^{T} ( k )}{λ + {‖ \hat{Φ} ( k ) ‖}^{2}} + β {Φ}_{c} ( k ) K ) ] + {ε}_{1} \leq 1 - {M}_{1} + {ε}_{1} < 1 \qquad ( 27 )$$
wherein ∥M∥ᵥ is the compatible norm of matrix M;
β exists such that B satisfies the following inequality:
1>1−A≤M₁−ε₁>B>0 (28)
from formulas (16) and (28), obtaining:
∥e(k+1)∥ᵥ≤A∥e(k)∥ᵥ+B∥e(k−1)∥ᵥ<(1−B)∥e(k)∥ᵥ+B∥e(k−1)∥ᵥ (29)
after transposition, obtaining:
∥e(k+1)∥ᵥ−∥e(k)∥ᵥ<−B(∥e(k)∥ᵥ−∥e(k−1)∥ᵥ) (30)
based on formula (30), discussing the form of e(k) from the following four aspects:
in a first case, when ∥e(k+1)∥ᵥ>∥e(k)∥ᵥ and ∥e(k)∥ᵥ>∥e(k−1)∥ᵥ, obtaining
∥e(k+1)∥ᵥ−∥e(k)∥ᵥ>−B(∥e(k)∥ᵥ−∥e(k−1)∥ᵥ) (31)
which is the opposite of formula (30); therefore, this assumption does not exist;
in a second case, when ∥e(k+1)∥ᵥ>∥e(k)∥ᵥ and ∥e(k)∥ᵥ<∥e(k−1)∥ᵥ from formula (30), obtaining:
$$\frac{{‖ e ( k + 1 ) ‖}_{v} - {‖ e ( k ) ‖}_{v}}{{‖ e ( k - 1 ) ‖}_{v} - {‖ e ( k ) ‖}_{v}} < B < 1 \qquad ( 32 )$$
i.e., the decrease of e(k) is larger than the increase in three adjacent sampling points; and as a result, the overall trend is decreasing under this situation;
in a third case, when ∥e(k+1)∥ᵥ<∥e(k)∥ᵥ and ∥e(k)∥ᵥ<∥e(k−1)∥ᵥ, obtaining
$$\frac{{‖ e ( k + 1 ) ‖}_{v}}{{‖ e ( k ) ‖}_{v}} < 1 and \frac{{‖ e ( k ) ‖}_{v}}{{‖ e ( k - 1 ) ‖}_{v}} < 1 \qquad ( 33 )$$
which satisfies formula (30), and e(k) has a decreasing trend in this case;
in a fourth case, when ∥e(k+1)∥ᵥ<∥e(k)∥ᵥ and ∥e(k)∥ᵥ>∥e(k−1)∥ᵥ, according to formula (30), this situation may exist; two possibilities exist in the time of k+2 in detail: if ∥e(k+2)∥ᵥ>∥e(k+1)∥ᵥ exists, obtaining the same conclusion as the second case; if ∥e(k+2)∥ᵥ<∥e(k+1)∥ᵥ, obtaining the same conclusion as the third case; in short, e(k) still has a decreasing trend in this case;
the above methods of proof are also applicable when f(k)=0; to sum up, the overall trend of error e(k) is decreasing; therefore, the convergence of the error is proved;
step D: applying the above control algorithm to control of an aero-engine model, and selecting three different cases for result comparison to verify the effectiveness and superiority of the control algorithm; firstly, comparing the control effects of MFAC+Kp, CFDL-MFAC and PID under the standard conditions to illustrate the effectiveness of an improved controller; and then, comparing the control effects at different heights and different delays to illustrate the superiority of the controller.
